(19) United States
(12) Patent Application Publication
(10) Pub. No.: US 2005/0034881 A1
(43) Pub. Date: Feb. 17, 2005

(54) Drilling and/or striking hammer with a lubricating device

(76) Inventors: Rudolf Berger, Grunwald (DE); Wolfgang Schmid, Munchen (DE)

Correspondence Address: Timothy E Newholm;Boyle Fredrickson Newholm Stein & Gratz, 250 Plaza, Suite 1030, 250 East Wisconsin Avenue, Milwaukee, WI, 53202, US

(21) Appl. No.: 10/499,567

(22) PCT Filed: Dec. 11, 2002
(86) PCT No.: PCT/EP02/14065

(30) Foreign Application Priority Data
Dec. 21, 2001 (DE) 10163278.9

(51) Int. Cl. B25D 1/00

(52) U.S. Cl. 173/2; 173/201; 173/171

(57) ABSTRACT

Disclosed is a drilling and/or striking hammer comprising a lubricating device provided with a lubricant reservoir and a supply lubricant contained therein. A dosage device is provided with a dosage opening connecting the supply of lubricant to a place to be lubricated. Said invention also comprises a pressure generating device by means of which the supply of lubricant can at least temporarily be subjected to an increased amount of pressure, whereby lubricant exists from the dosage opening, allowing targeted lubrication of the movable parts.

The present invention relates, according to the preamble of patent claim 1, to a drilling and/or striking hammer having a lubricating device.

A drilling and/or striking hammer of this sort, designated a hammer below, is known from DE 39 36 849 A1. There, in a cover a depression is formed in which a high-viscosity grease is contained that can gradually flow through a dosing opening into a glide bearing between a crank bolt and a connecting rod. The dispensing of the lubricant takes place randomly, and is possible only when the hammer is in a suitable position, because gravitational support is required.

In EP 0 861 997 B1, a hand tool having a lubricated angular gear is described. There, a reservoir of lubricant is provided in the form of a pot that is open at the top, through which there passes a rotating spindle shaft. In the pot, a metal ball can move in such a way that due to the housing vibrations it tumbles through the lubricant, which is likewise located in the pot. In the base of the pot, a dosing opening is provided through which lubricant is occasionally pressed downwards due to the random motion of the metal ball; in this way, the lubricant reaches a ball gear for lubrication. Here as well, the lubrication takes place randomly and cannot take place independent of position.

The present invention is based on the object of indicating a drilling and/or striking hammer in which a lubricant can be supplied reliably, independent of position, and independent of random influences.

According to the present invention, this object is achieved by a drilling and/or striking hammer according to patent claim 1. Advantageous further developments of the present invention are defined in the dependent claims.

The handheld drilling and/or striking hammer according to the present invention, designated a hammer below, has a dosing device in which, on the one hand, a dosing opening is provided that brings a supply of lubricant into communication with a point to be lubricated, and on the other hand a conveying device is provided that conveys the lubricant from the lubricant supply through the dosing opening to the point to be lubricated. The conveying device is fashioned in such a way that, using it, the lubricant can be conveyed from the lubricant supply through the dosing opening to the point to be lubricated on the basis of a controlled or predetermined path displacement effect or dynamic effect. Whereas the lubricating devices known from the prior art enable a merely random lubricating effect, which in addition require the hammer to be in a particular position in order for lubricant to be able to reach the point to be lubricated, the conveying means according to the present invention ensures a lubrication that can be predetermined and calculated, as well as being independent of position.

If the conveying means conveys lubricant based on a path effect, it typically has a suitable conveying element, e.g. a conveying coil, that can be situated in the dosing opening in order to convey the lubricant through the dosing opening.

A controlled path or gravitational effect enables lubrication suited to the needs of the situation, and can for example be achieved in that the stress on the hammer or on individual components, and the need for lubrication resulting therefrom, is determined by a stress acquisition means (explained below) that supplies the determined information to a suitable control unit. The control unit then controls the path or force effect of the conveying means.

Alternatively, the path or force effect can also be predetermined by a suitable design of the conveying means. This is for example possible in that during the operation of the hammer a flow of lubricant is realized that is continuous or is intermittent, and is constant over time. The conveying of lubricant is then independent of stress. However, it can be predetermined in such a way that sufficient lubrication is ensured in all operating states.

In a particularly advantageous specific embodiment of the present invention, the conveying means produces a combined path and force effect in order to convey the lubricant. For this purpose, the conveying means has a pressure-producing means with which the lubricant supply can at least at times be placed under increased pressure. Due to the fact that the supply of lubricant can be placed under pressure, a controlled driving of the lubricant out of the lubricant reservoir through the dosing opening to the point to be lubricated can be realized.

Preferably, the lubricant supply can be placed under a degree of pressure that is higher than that of the environment surrounding the point to be lubricated. In this way, it is ensured that even when there are pressure fluctuations in the area of the point to be lubricated, as is the case for example in the crank chamber housing the crankshaft or in the area of the percussion mechanism of the hammer, there exists a difference in pressure between the lubricant in the lubricant reservoir and the area surrounding the point to be lubricated, so that lubricant can reliably be conveyed to the point to be lubricated. The lubricant can then be conveyed from the area surrounding the point to be lubricated to the actual point to be lubricated (for example, to a bearing point for the crankshaft or to a sliding surface between moving pistons in the percussion mechanism) without additional effort.

In a particularly advantageous further development of the present invention, the pressure-producing means comprises a spring device and/or an actuating element. The spring device or the actuating element can act on the lubricant supply directly or also via a movable separating element, such as a membrane or a piston. The spring device can thereby comprise any type of spring, in particular a gas spring or a helical spring, or also a plurality of springs.

In an advantageous specific embodiment of the present invention, as a pressure-producing device a helical spring made of what is known as a Amemory@ material is used in which the actual spring force is not exerted until a particular temperature has been reached. In this way, for example pressure can be produced on the lubricant supply, resulting in a dispensing of lubricant, only when the hammer has reached a particular operating temperature that is higher than room temperature, and the memory spring has been correspondingly heated. In this way, an expensive control or regulation mechanism becomes superfluous. If, in place of the spring device, an actuating element is used, a control unit can be provided that drives an actuating element according to the particular case of application.

In a particularly advantageous specific embodiment of the present invention, the lubricant receptacle is fastened in exchangeable fashion on or in a housing of the hammer. In this way, the lubricant receptacle can be provided in the form of an exchangeable cartridge that can be exchanged by the operator at predetermined time intervals or in response to a corresponding signal. In this way, it is possible to avoid a difficult, dirty filling of the lubricant reservoir, for example using a grease gun, which may not be available at the site of use of the hammer.

In a particularly advantageous further development of the present invention, a valve device is provided in the dosing opening, which opening can also be realized in the form of a dosing duct; using this valve, the dosing opening can be opened, and can be closed at least in one direction of flow. Thus, for example, a check valve can be used in the dosing opening that prevents contaminated or used lubricant from flowing back into the lubricant reservoir.

If the valve device can be controlled via a valve control unit, it is even possible to deliberately control a delivery of the lubricant dependent on the state of the lubricant or other operating states. For this purpose, it is particularly advantageous if the supply of lubricant is permanently placed under pressure by the pressure-producing means during the operation of the hammer. The delivery of the lubricant can then be controlled merely by controlling the valve device.

In a particularly advantageous specific embodiment of the present invention, a stress acquisition means is provided with which a current and/or long-term stress on the hammer can be determined. As a criterion for the current amount of stress on the hammer, a temperature inside the hammer housing, a lubricant temperature, or also a vibration amplitude can be acquired. As a criterion for long-term degree of stress, suitable criteria include for example the operation time since the last maintenance, a cumulative current or power consumption over the operating time, or also a total number of rotations of a drive of the hammer since the last maintenance.

If necessary, the stress-acquisition means has a sensor or counting device for the acquisition of a suitable criterion.

In an advantageous further development of the present invention, a stress signal produced by the stress-acquisition means can be supplied to an evaluation means that correspondingly drives the valve control device in order to open or close the valve that seals the dosing opening, or to interrupt a supply of power to the drive of the hammer. Alternatively, the evaluation means can also drive the control unit of the actuating element. In this way, the stress signal, based on the suitable criterion, can be used for the automatic controlling of the delivery of the lubricant.

In another specific embodiment of the present invention, the stress signal is supplied to a display means that informs the operator of the state of stress or of the fact that maintenance is needed via an optical or acoustic signal. Such an inspection display makes it possible for the operator to recognize ahead of time whether the hammer needs to undergo extensive maintenance, or whether for example the lubricant reservoir merely needs to be filled with lubricant. On the basis of the different stress criteria, here it is possible to provide the operator with differentiated information.

In order to ensure a constant delivery of lubricant to the point or points inside a hammer that are to be provided with lubricant, it is particularly useful if used or contaminated lubricant can be removed from the interior of a hammer housing, for example from the crank chamber or away from the area of a percussion mechanism. This is possible via an area of a machine housing that brings the point to be lubricated into communicating connection with the surrounding environment.

These features, and additional features and advantages of the present invention, are explained in more detail below on the basis of examples, with the aid of the accompanying Figures.

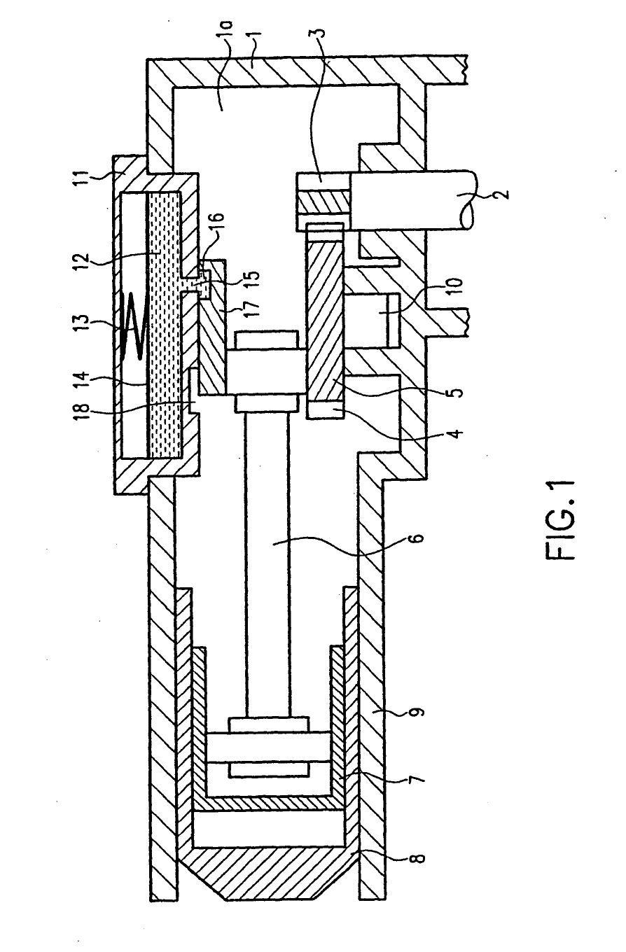

FIG. 1 shows a schematic section through a percussion mechanism of a drilling and/or striking hammer according to the present invention;

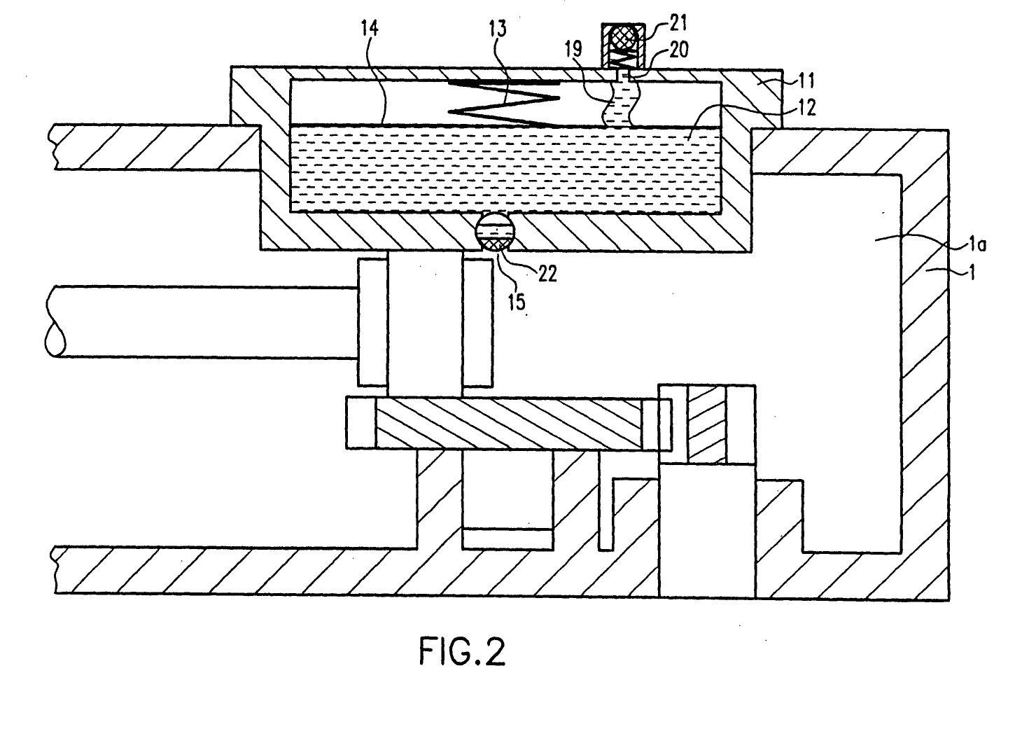

FIG. 2 shows an enlarged sectional representation of a second specific embodiment of the present invention;

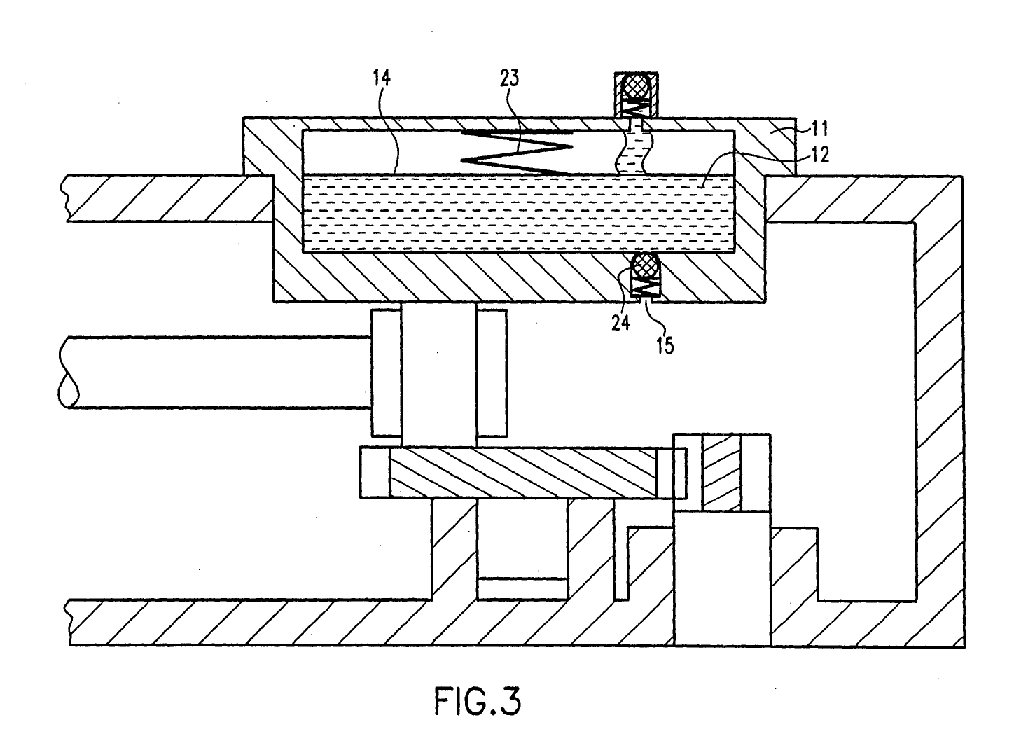

FIG. 3 shows an enlarged schematic sectional representation of a third specific embodiment of the present invention; and

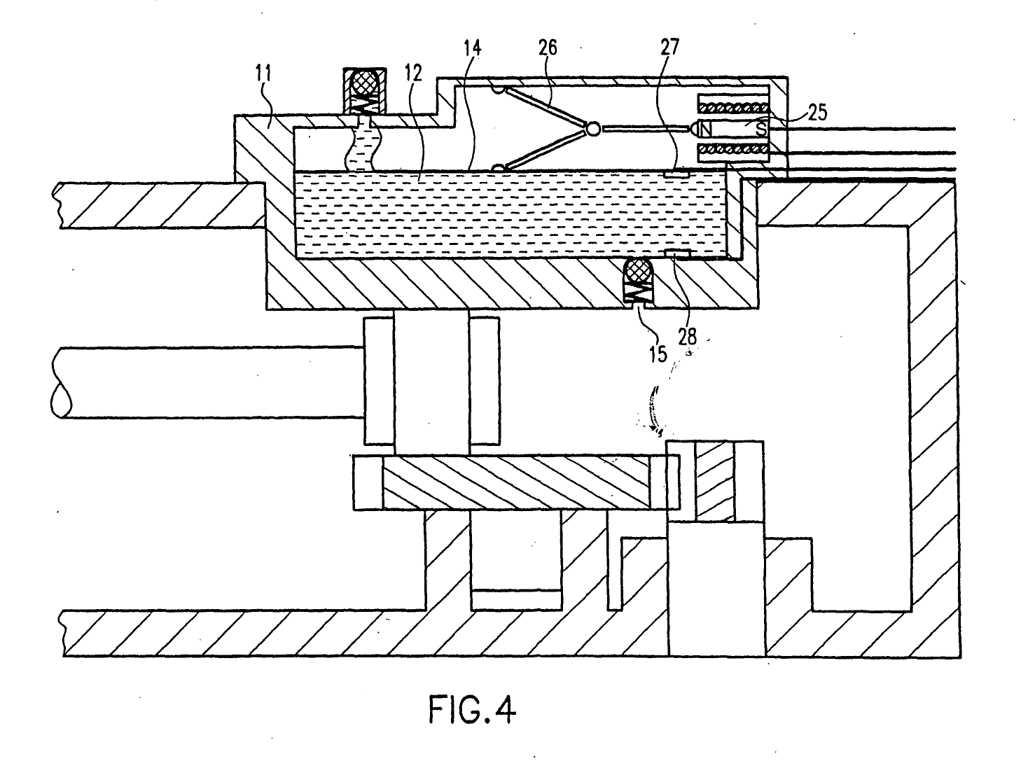

FIG. 4 shows an enlarged sectional representation of a fourth specific embodiment of the present invention.

FIG. 1 shows, in a schematic sectional representation, a first specific embodiment of the present invention, in the form of a known percussion mechanism in a drilling and/or striking hammer, designated a hammer below.

In a crank chamber 1a of a housing 1, a drive shaft 2 of a drive motor (not shown) is mounted, which shaft drives a toothed wheel 4 rotationally via a pinion gear 3. Toothed wheel 4 is a component of a crankshaft 5 that drives a connecting rod 6 back and forth.

At the other end of connecting rod 6, there is connected a drive piston 7 that can be moved axially back and forth in a hollow receptacle of a percussion piston 8. Percussion piston 8 is held in what is known as a percussion mechanism tube 9, which can be a component of housing 1, so as to be likewise capable of axial movement. During operation, percussion piston 8 strikes a shaft (not shown) of a machine, or an intermediately connected snap die.

The functioning of such a percussion mechanism has long been known and extensively described, so that further description is not necessary.

Crankshaft 5 is mounted on one side of housing 1 by means of a cog 10. On the opposite side, crankshaft 5 can likewise be mounted in a known manner with the aid of a cog (not shown). Alternatively, it is possible to provide, opposite cog 10, what is known as a Asupport boss,@ as known for example from DE 198 20 218 A1. An axial force acting on crankshaft 5 can thereby be supported, via a crown contour situated at the height of the axis of rotation of crankshaft 5, on an inner side of housing 1. The area of this support must be well lubricated (a point of lubrication).

In axial prolongation of crankshaft 5, a lubricant reservoir is provided that comprises, as a lubricant container, a lubricant receptacle 11, as well as a supply of lubricant 12 contained therein.

As a lubricant, high-viscosity grease is preferably used. Of course, it is however also possible to use low-viscosity grease-based lubricants or oil. However, grease is particularly well suited due to its easier sealability.

In a variant not shown in FIG. 1, lubricant receptacle 11 can also be fastened to housing 1 of the hammer in exchangeable fashion as a cartridge. When lubricant supply 12 is used up, the operator merely has to exchange lubricant receptacle 11, replacing it with a new one.

Lubricant supply 12 inside lubricant receptacle 11 is placed permanently under pressure by a pressure-producing means. The pressure-producing means has a spring 13 and a piston 14 charged by the spring. Through the action of spring 13 and piston 14, lubricant 12 is permanently pressed against a dosing opening 15 formed in the floor of lubricant receptacle 11.

Dependent on a rotational position of crankshaft 5, dosing opening 15 corresponds with a recess 16, which acts as a ladle, fashioned in a disk of crankshaft 5. If recess 16 rotates further as a result of the rotational motion of crankshaft 5, dosing opening 15 is again closed by disk 17.

When recess 16 has rotated approximately 180°, it corresponds with a removal point 18 at which the lubricant is accelerated out of recess 16, and can move into the interior of housing 1, i.e., into crank chamber la or percussion mechanism tube 9.

The cross-section of dosing opening 15 can be formed dependent on the viscosity of the lubricant used. In the case of low-viscosity lubricants, it can also be useful to fasten an insert in dosing opening 15 in order to reduce the cross-sectional surface of dosing opening 15.

Particularly important points to be lubricated include on the one hand the bearing points of crankshaft 5 and the gear mechanism that rotates the crankshaft, made up of pinion gear 3 and toothed wheel 4, as well as, on the other hand, the actual percussion mechanism, made up of drive piston 7, percussion piston 8, and percussion mechanism tube 9. In the percussion mechanism in particular, due to the large power conversion and the friction connected therewith, very high temperatures can be reached which urgently require sufficient lubrication, thus placing high demands on adequate lubrication and on the lubricant.

Of course, the crankshaft can also be mounted and lubricated in another manner, as is shown in FIG. 1.

Instead of piston 14 and spring 13, a gas pressure spring or a gas supply under pressure can also be used that presses against a membrane that acts as a piston. Different possibilities for producing pressure in lubricant supply 12 are known to those skilled in the art, so that a detailed description is not necessary.

FIG. 2 shows a second specific embodiment of the present invention, as a variant of FIG. 1. Because the drive system, made up of crankshaft, connecting rod, and percussion mechanism, is unchanged, and to this extent also does not relate to the subject matter of the present invention, a repeated description is omitted.

In lubricant receptacle 11 there is contained lubricant supply 12, which, as in FIG. 1, is placed under pressure by a spring 13 and a piston 14, shown only schematically.

Lubricant supply 12 is connected with a refill opening 20 via duct 19, and a check valve 21 is situated before this refill opening. Via check valve 21 and refill opening 20, as well as duct 19, lubricant supply 12 can be refilled with lubricant. This can for example be accomplished using a grease gun, in a known manner.

A valve apparatus 22 is placed into dosing opening 15. Valve apparatus 22 shown in FIG. 2 is made up of a rotatable valve element through which a bore passes. According to the position of the valve element, dosing opening 15 is opened, so that lubricant can flow from lubricant supply 12 into crank chamber la in the interior of housing 1, or dosing opening 15 is closed.

A controlling of valve apparatus 22 takes place by means of a valve control device (not shown). There are many possible criteria for controlling valve apparatus 22. For example, the opening of dosing opening 15 by valve apparatus 22 can take place intermittently at predetermined time intervals whenever the hammer is in operation. This controlling is very simple, but has the disadvantage that the lubrication may not meet the needs of the actual situation.

For this reason, it is particularly advantageous if, with the aid of a stress acquisition device (not shown), an actual current or long-term stress on the hammer can be determined. A suitable criterion for the stress is, for example, the temperature inside the drilling hammer. Whenever the temperature reaches a particular value, the stress acquisition means recognizes that the hammer is in operation and is exposed to a corresponding stress. The temperature can preferably be acquired by a temperature sensor.

Another possibility is to use suitable sensors to determine the quantity of lubricant in the area of the point to be lubricated, i.e., here, at the bearing points of crankshaft 5, at the teeth, or in the percussion mechanism.

In addition, the (remaining) quantity of lubricant in the lubricant reservoir can be acquired in order to indicate to the operator in a timely fashion when lubricant supply 12 must be refilled, or lubricant receptacle 11 must be replaced by a new one.

Other criteria for the stress on the hammer include the time of operation (e.g., since the last maintenance), the total, i.e., accumulated, current or power consumption over the time of operation, or also the total number of rotations of the drive of the hammer. In particular in hammers having an electronically controlled drive, it is possible, without great expense, to acquire the power consumption or the drive frequency or rotational speed and to sum this over the time of operation. When predefined intermediate or boundary values have been reached, valve apparatus 22 can be actuated in order to open dosing opening 15.

In addition, it is possible to use the information obtained in this way for displaying a maintenance state of the hammer.

In the course of preliminary tests, it has been determined how many operating hours, motor rotations, etc., are possible for the hammer with one filling of lubricant receptacle 11, and, correspondingly, when it will be necessary either to refill lubricant supply 12 or to perform a larger maintenance operation on the hammer. The operator can be informed of this in a timely fashion using acoustic or optical signals. Thus, the operator is not required, as in the past, to monitor maintenance intervals himself and to adhere to a maintenance schedule. Rather, the monitoring function is integrated completely into the hammer according to the present invention. This can go as far as to include the feature that the stress acquisition means, or an evaluation means that evaluates a corresponding stress signal, switches off the drive motor of the hammer when the maintenance state of the hammer is such that there is a risk of permanent damage.

With the aid of the stress acquisition means and the evaluation means, supplied by the stress acquisition means with a corresponding stress signal, and with the aid of the display means, it is possible for the operator to be informed at all times as to whether it is necessary to refill lubricant, to exchange lubricant receptacle 11, which is fashioned as an exchangeable cartridge, or to perform a general maintenance operation on the hammer.

FIG. 3 shows an additional specific embodiment of the present invention, in which, in place of spring 13, what is known as a memory spring 23 is used, which acts on piston 14, and thus on lubricant supply 12 inside lubricant receptacle 11.

The capacity for refilling lubricant supply 12 is realized in a manner similar to that in the second specific embodiment according to FIG. 2, so that a repeated description is unnecessary.

In dosing opening 15 there is placed a check valve 24 in order to prevent used or contaminated lubricant from flowing back into lubricant supply 12. Via check valve 24, it is thus possible only to bring fresh lubricant out of lubricant supply 12.

Memory spring 23 is made of a special, known steel, and has the property that it strives to return to its original shape, and in this way to exert a spring force on piston 14 and thus on lubricant supply 12, only when a predetermined temperature value has been exceeded. This fact is advantageously exploited in that the necessary spring force for pressing lubricant out of dosing opening 15 is not produced until a heating of the hammer, and thus of memory spring 23, has taken place during operation of the hammer.

This variant has the great advantage that further control devices and sensors are rendered superfluous, which additionally increases, in particular, the operational reliability of the hammer.

In FIG. 4, a fourth specific embodiment of the present invention is shown that, in contrast to FIG. 3, is characterized by a pressure-producing device that is particularly expensive but that can be set with a high degree of sensitivity.

Lubricant supply 12 in receptacle 11 is placed under pressure by an actuating element 25 and by a lever mechanism 26 that is charged by actuating element 25 and that acts against piston 14. It is hereby sufficient under certain circumstances to provide only a slight increase in pressure in lubricant supply 12 in order to achieve a continuous flow of lubricant through dosing opening 15.

Actuating element 25, which operates electromagnetically, can on the one hand be excited by a constant current in order to exert a largely constant force on piston 14, whereby lever mechanism 26 is to be constructively adapted thereto if necessary. Alternatively, it is also possible to set the force that can be produced by actuating element 25, and thus the pressure action on lubricant supply 12, dependent on the actual stress on the hammer. For this purpose, the signal from the stress acquisition means is correspondingly evaluated and is supplied to actuating element 25.

As already described, it is useful for the operator to be informed concerning the degree of filling of lubricant receptacle 11, in particular when lubricant receptacle 11 has been emptied. For this purpose, in the fourth exemplary embodiment a contact sensor is provided that has a first contact 27, situated on piston 14, and a second contact 28, provided on the floor of lubricant receptacle 11. When first contact 27 and second contact 28 come into contact with one another, a control current circuit is closed and a corresponding signal is produced that can inform the operator, via a display, that lubricant supply 12 has become empty.

Of course, many other means known to those skilled in the art can also be used for displaying the filling state.

Instead of the electromagnetic actuating element shown in FIG. 4, other types of actuating elements are also possible, such as for example actuating elements having motor-driven, electromechanical, or piezoelectric active elements. The task of the actuating element is only to charge piston 14 or a corresponding membrane with a force in such a way that lubricant supply 12 is placed under pressure.

In practice, it has turned out that the lubrication is particularly effective if used or contaminated lubricant can be removed from the inside of the housing. For this purpose, in the hammer according to the present invention there is provided, in the area of a tool guide (not shown) or an insertion end for a tool shaft, an opening (though a small one) in the form of a gap or a purposeful leak, through which the lubricant can exit housing 1. In this way, to a certain extent a regeneration of the lubricant inside housing 1 is achieved.

From the above description, it can be seen that the present invention can be realized in numerous variants. Thus, on the one hand there are various possibilities for producing a pressure in lubricant supply 12, of which only a few have been explained above. The valve controlling, or the indication of the maintenance state, can also be realized in various ways. To this extent, the above description is to be understood merely as an explanation of some examples, and not as a limitation of the scope of the claimed invention.

1. A handheld drilling and/or striking hammer having a percussion mechanism and having a lubricating device for lubricating the percussion mechanism, comprising
a lubricant reservoir that comprises a lubricant receptacle and a supply of lubricant contained therein; and
a dosing means that comprises a dosing opening that connects the lubricant supply (12) with a point to be lubricated;
wherein the dosing means comprises a conveying means with which the lubricant can be conveyed on the basis of a controlled or predetermined path and/or force effect from the lubricant supply through the dosing opening to the point to be lubricated, in a manner that meets the existing need for lubrication.

2. The drilling and/or striking hammer as recited in claim 1, wherein the conveying means comprises a movable conveying element that is provided in the dosing opening, whose motion conveys the lubricant to the point to be lubricated.

3. The drilling and/or striking hammer as recited in claim 1, wherein the conveying means comprises a pressure-producing means with which the supply of lubricant can at least at times be placed under an increased pressure.

4. The drilling and/or striking hammer as recited in claim 3, wherein the pressure-producing means comprises a spring device and/or an actuating element, whereby the spring device and/or the actuating element acts on the supply of lubricant directly or via a movable separating element.

5. The drilling and/or striking hammer as recited in claim 4, wherein the spring device comprises at least one gas spring, a conical wire spring, a plate spring, or a helical spring.

6. The drilling and/or striking hammer as recited in claim 5, wherein the helical spring is made of a material that, at a temperature above a determined temperature that is higher than a room temperature, assumes a different shape and spring characteristic than is the case below this determined temperature value, so that when heated to a temperature above the determined temperature value, the helical spring exerts a significantly higher pressure on the supply of lubricant than is exerted when the temperature of the helical spring lies below the determined temperature value.

7. The drilling and/or striking hammer as recited in claim 4, wherein the actuating element can be driven via a control unit, and/or comprises motor-driven, electromechanical, electromagnetic and/or piezoelectric active elements.

8. The drilling and/or striking hammer as recited in claims 1, wherein the lubricant receptacle is fastened on or in a housing of the drilling and/or striking hammer in exchangeable fashion.

9. The drilling and/or striking hammer as recited in claim 8, wherein the lubricant receptacle has a refill opening via which the supply of lubricant can be filled.

10. The drilling and/or striking hammer as recited in claims 1, wherein in the dosing opening there is provided a valve device with which the dosing opening can be opened, and can in at least one direction of flow be closed.

11. The drilling and/or striking manner as recited in claim 10, wherein the valve device can be controlled via a valve control means.

12. The drilling and/or striking hammer as recited in claim 11, wherein the dosing opening can be completely closed by the valve device, and that the supply of lubricant can be placed permanently under pressure by the pressure-producing means at least during the operation of the drilling and/or striking hammer.

13. The drilling and/or striking hammer as recited in claims 1, wherein
a stress acquisition means is provided with which a current and/or long-term stress on the drilling and/or striking hammer can be determined; and
the determination of the stress takes place through the acquisition of at least one criterion, selected from the group: temperature in the interior of the drilling and/or striking hammer, lubricant temperature, quantity of lubricant in the area of the point to be lubricated, quantity of lubricant in the lubricant reservoir, quality of lubricant and/or lubricant purity in the area of the point to be lubricated, operating time, overall current consumption over the operating time, overall power consumption over the operating time, overall number of rotations of a drive of the drilling and/or striking hammer over the operating time, vibration strength, development of noise.

14. The drilling and/or striking hammer as recited in claim 13, wherein the operating time is the sum of all time periods in which the drilling and/or striking hammer is in operation after a particular point in time, in particular the time of the last maintenance.

15. The drilling and/or striking hammer as recited in claim 13, wherein the stress acquisition device comprises at least one sensor device.

16. The drilling and/or striking hammer as recited in claims 13, wherein a stress signal corresponding to the stress can be produced by the stress acquisition device.

17. The drilling and/or striking hammer according to claim 11, wherein the stress signal can be supplied to an evaluation means that, dependent on the stress signal, drives the valve control device in order to open or close the valve, and/or interrupts a supply of power to the drive and/or drives the actuating element of the pressure-generating means.

18. The drilling and/or striking hammer according to claim 16, wherein the stress signal can be supplied to a display means in order to output an optical or acoustic signal dependent on the stress corresponding to the stress signal, and/or in order to output a signal for providing information concerning the need for a maintenance operation.

19. The drilling and/or striking hammer as recited in claims 1, wherein the point to be lubricated stands in communicating connection with the surrounding environment via an area of a tool holding fixture, in order to remove used or contaminated lubricant.
